(19) United States
(12) Patent Application Publication
(10) Pub. No.: US 2004/0173043 A1
(43) Pub. Date: Sep. 9, 2004

(54) Car-powering automatic hand brake device

(76) Inventor: Tsao-Hui Huang, Banchiau City (TW)

Correspondence Address: Tsao-Hui HUANG, P.O. Box No. 6-57, Chung-Ho, Taipei, 235, TW

(21) Appl. No.: 10/378,632

(22) Filed: Mar. 5, 2003

(51) Int. Cl. F16C 1/12

(52) U.S. Cl. 74/501.6

(57) ABSTRACT

The present invention provides a car-powering automatic hand brake device; an electronic controller thereof connects with the ignition switch and a driving device respectively. Therefore, when the driver parks the car and turns off the ignition switch, the electronic controller automatically turns on and starts the driving device. The driving device tightens the brake cable of the brake apparatus thereby braking the car wheels. In addition, when the driver turns on the car, the driving device reverses releasing the brake cable and then the car runs.

### BACKGROUND OF THE INVENTION

1) Field of the Invention

The present invention relates to a car-powering automatic hand brake device, more particularly to a device which is connected with an electronic controller through a driving device (e.g. a motor); it automatically locks the car wheels when parking and releases them on startup. It can replace manual operation effectively. The function mentioned above is completed without pulling the hand brake lever when parking, and therefore avoids the confusion in fail to release the hand brake lever. A locking device can be added to the electronic controller of the invention hereof, so thieves are unable to release the brake thereby achieving the effect of theft prevention.

2) Description of the Prior Art

The conventional hand brake device (referring to FIG. 1) relates to a hand brake lever (1) installed in the car and connected to the brake apparatus (3) via a brake cable (2). When parking, the hand brake lever (1) is pulled, and thus the brake cable (2) is tightened thereby achieving the function of braking; on startup, the button (4) on the hand brake lever (1) is pressed, which loosens said brake cable (2) and releases the brake. However, such operations have to be completed every time when the driver parks the car; it is labor consuming and troublesome, and drivers often forget to release the hand brake lever (1), which leads to the damage of car components. This often causes confusion and therefore is the disadvantage of the conventional hand brake device.

In order to solve the problem of said conventional hand brake device, having done long-term research and experiments, the inventor has finally developed and designed the present invention, a car-powering automatic hand brake device.

### SUMMARY OF THE INVENTION

The purpose of the present invention is to provide a hand brake device which automatically locks while parking and releases on startup; the hand brake device saves drivers time and labor, and makes it easier and more convenient for drivers. What mentioned above are the functions and purposes of the present invention.

To enable a further understanding of the structure and functions of the invention hereof, the brief description of the drawings below are followed by detailed description of the most preferred embodiment of the present invention.

### BRIEF DESCRIPTION OF THE DRAWINGS

FIG. 1 is a plan view and pictorial drawing of the preferred embodiment of the conventional hand brake device.

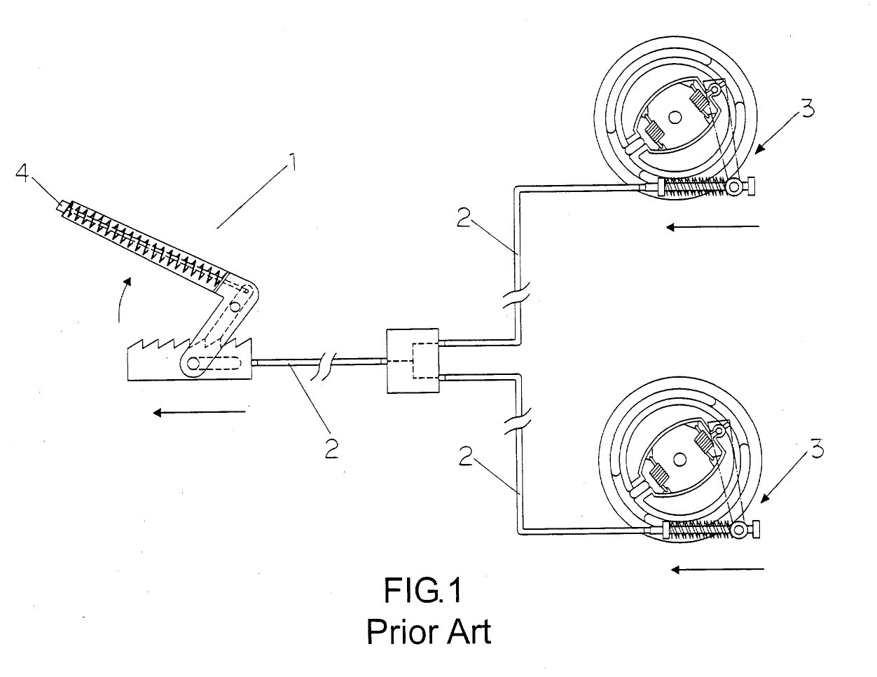

FIG. 2 is a plain view schematic drawing of the preferred embodiment of the present invention.

### DETAILED DESCRIPTION OF THE PREFERRED EMBODIMENTS

The purpose of the present invention relates to a car-powering automatically hand brake device, which contains three main components. Their functions and characteristics are explained as follows:

1. A driving device (5): a non-man power resource such as a motor, an engine, etc. The preferred embodiment of the present invention herein is a worm reduction motor with functions of forwarding and reversing.

2. An electronic controller (7): an electronic circuit design which, in the present invention, connects to an ignition switch (8) and the driving device (5) respectively. The on/off of the ignition switch (8) starts up an electronic circuit which enables the electronic controller (7) to automatically control the forwarding and reversing of the driving device (5) and the spinning time (the length of the spinning time is adjustable) thereby completing the functions of braking and releasing. An auto/manual switch can be designed on the electronic controller (7) of the invention herein, so drivers can have different choices according to the driving conditions.

3. A brake cable (2): a steel cable which can tighten the brake apparatus. The brake cable (2) in the present invention connects the driving device (5) and brake apparatus. By the forwarding and reversing of the driving device (5), the brake cable (2) can tighten and release the brake apparatus.

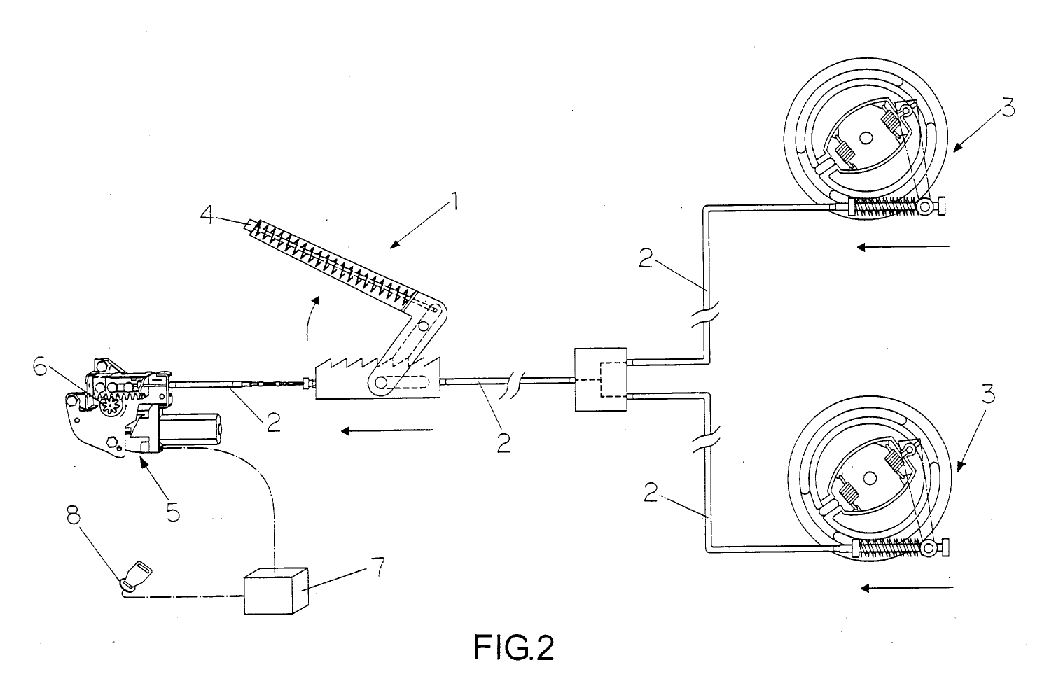

The functions and characteristics of three main components are mentioned above; the detail descriptions of the structure and performance are as follows. Please referring to FIG. 2, the present invention relates to an electronic controller (7) and a driving device (5) installed in an appropriate location in the car. (The preferred embodiment of the present invention is a worm reduction motor. However, it should not be limited in applications) Said electronic controller (7) connects to the ignition switch (8) and the driving device (5) respectively. The driving device (5) herein connects to the existing hand brake apparatus (3) in the car via the brake cable (2). When a driver parks the car and turns off the ignition switch (8), the electronic controller (7) automatically runs the driving device (5) for an adequate forwarding time (the length of the locking time is adjustable). A draft gear (6) disposed on the driving device (5) herein tightens the brake cable (2) and thus locks the car wheels; then the electronic controller (7) cuts off the power of the driving device (5), a worm reduction motor herein. When the power of the motor is off, the motor is not reversed by the counterforce from tightening the brake cable (2) (because the worm interlocks with said gear). Therefore, the car wheels are tightly braked and will not be released automatically. Since the power of the driving device (5) is off, the electricity is not consumed while parking.

When the driver turns on the ignition switch (8) and starts the car, the electronic controller (7) automatically starts the driving device (5). Said driving device then reverses and releases the brake apparatus (3). Furthermore, the present invention can be switched to manual operation on the electronic controller (7), so the driver can choose the suitable operation according to the road condition (This is not shown in the drawing).

The present invention has been described with preferred embodiments thereof and it is understood that many changes and modifications in the described embodiments can be carried out without departing from the scope and the spirit of the invention that is intended to be limited only by the appended claims.

1. An car-powering automatic hand brake appliance comprises:
a driving device installed on an appropriate location in the car having a reduction apparatus being installed with a driving gear extended outward and connected with a brake cable; by the forwarding and reversing of the driving device, the functions of braking and releasing are achieved;
an electronic controller having an electronic circuit design connected to the ignition switch and driving device respectively; the main function thereof is to control the forwarding and reversing and the spin time of the driving device by the on/off of the ignition switch;
a brake cable having a steel cable, the both ends thereof connect to the driving device and an existing hand brake apparatus respectively; the main function thereof is to tighten or release the hand brake apparatus through the forwarding and reversing of the driving device.

2. A structure for a car-powering automatic hand brake device of claim 1, wherein the electronic controller connects to the ignition switch and the driving device respectively, and the both ends of the brake cable connect to the driving device and the existing hand brake apparatus; when the driver parks the car and turns off the ignition switch, the electronic controller automatically starts the driving device to spin forward and tightens the brake cable on the driving device thereby braking the car; when the driver starts the car, the electronic controller automatically starts the driving device to spin reversely and release the brake.
